(19) United States
(12) Patent Application Publication
(10) Pub. No.: US 2026/0328029 A1
(43) Pub. Date: Oct. 22, 2026

(54) DOOR LOCKING SYSTEM FOR A VEHICLE

(71) Applicant: Kerina Cunningham, Port St Lucie, FL (US)

(72) Inventor: Kerina Cunningham, Port St Lucie, FL (US)

(21) Appl. No.: 19/181,555

(22) Filed: Apr. 17, 2025

(51) Int. Cl. E05C 19/18

(52) U.S. Cl. CPC E05C 19/186

(57) ABSTRACT

A locking system for securing doors of a vehicle shut by attaching them to a buckle receiver of an adjacent seat assembly includes a webbing has a first end and a second end. A buckle tongue is coupled to the first end of the webbing and is shaped and configured to releasably connect to a buckle receiver of a seat assembly of the vehicle. A door mount is coupled the webbing proximate to the second end of the webbing and is configured to mount the webbing to the door of the vehicle adjacent to the seat assembly.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to lock apparatuses and more particularly pertains to a new lock apparatus for securing doors of a vehicle shut by attaching them to a buckle receiver of an adjacent seat assembly.

### (2) Description of Related Art Including Information Disclosed Under 37 CFR 1.97 and 1.98

The prior art discloses lock apparatuses which mount to an inside face of a door for a vehicle to secure the door to another element inside a cabin of the vehicle, thereby preventing the door from being opened, even if the internal lock mechanism of the door is tampered with. In particular, U.S. Pat. No. 7,325,281 discloses a strap which extends between armrests formed in doors that are positioned opposite each other across an interior space of a cabin of the vehicle. The strap includes a buckle with a buckle tongue that is receivable into a latching buckle receiver. However, the prior art fails to disclose such an apparatus which includes a buckle tongue that is adapted to releasably mount to a buckle receiver of a seat assembly of the vehicle. The prior art also fails to describe such an apparatus which mounts to a door by threading a hook at an end of a strap through a gap in the door and attaching the hook to an engagement structure on the strap.

### (h) BRIEF SUMMARY OF THE INVENTION

An embodiment of the disclosure meets the needs presented above by generally comprising a webbing has a first end and a second end. A buckle tongue is coupled to the first end of the webbing and is shaped and configured to releasably connect to a buckle receiver of a seat assembly of a vehicle. A door mount is coupled the webbing proximate to the second end of the webbing and is configured to mount the webbing to a door of the vehicle adjacent to the seat assembly.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a securement apparatus of a locking system according to an embodiment of the disclosure.

FIG. 2 is a top view of a securement apparatus of an embodiment of the disclosure.

FIG. 3 is a top view of an embodiment of the disclosure in which a pair of securement apparatuses secure doors to buckle receivers in a cabin of a vehicle.

### (j) DETAILED DESCRIPTION OF THE INVENTION

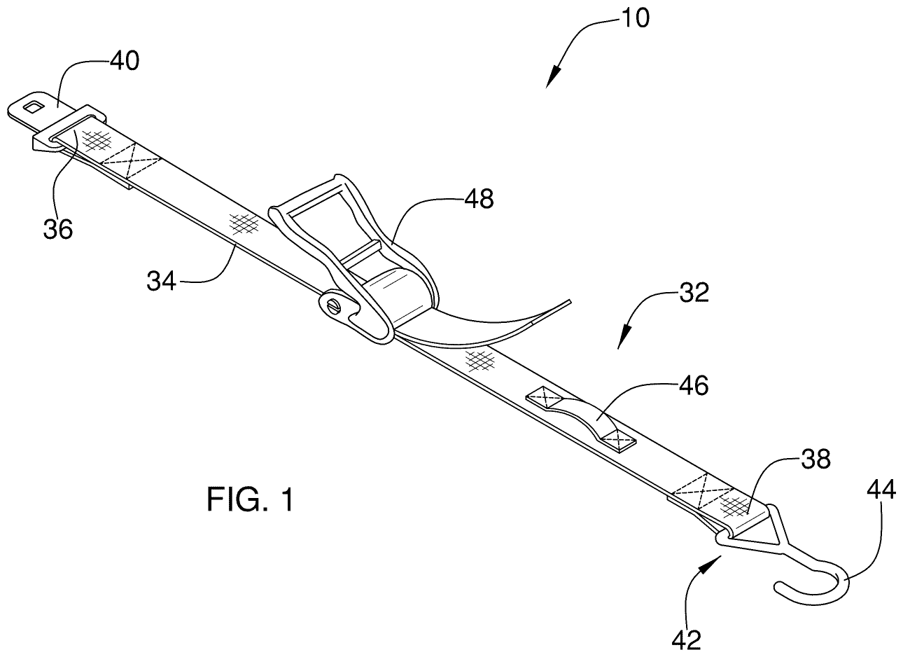

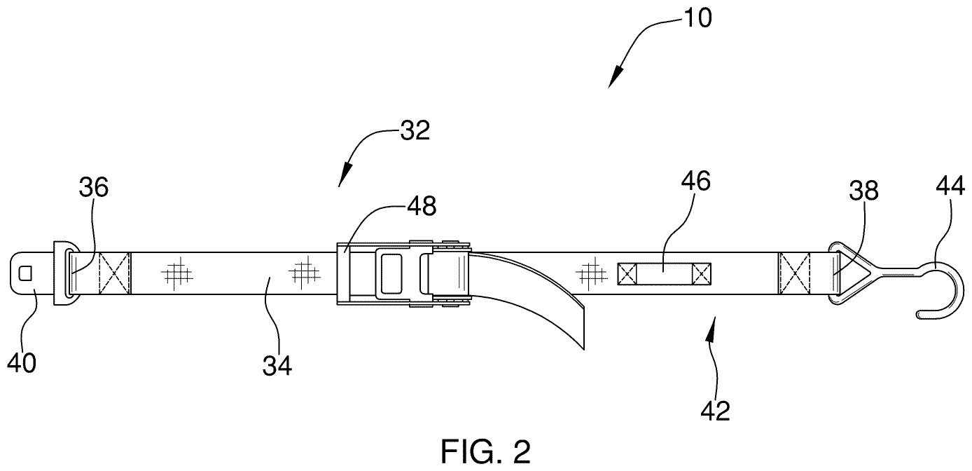

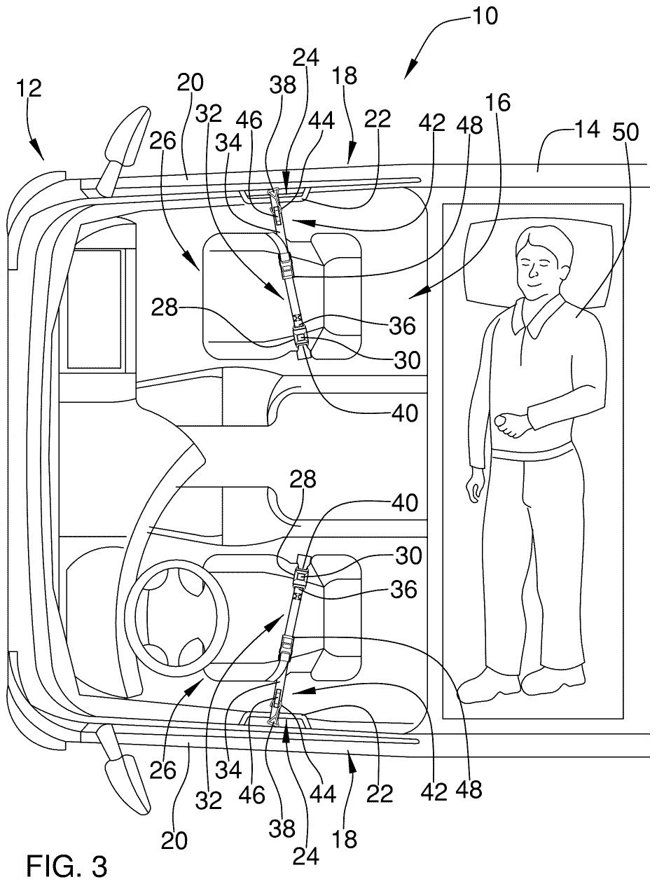

With reference now to the drawings, and in particular to FIGS. 1 through 3 thereof, a new lock apparatus embodying the principles and concepts of an embodiment of the disclosure and generally designated by the reference numeral 10 will be described.

As best illustrated in FIGS. 1 through 3, the locking system 10 generally comprises a vehicle 12 with a cabin 14 that has a pair of doors 18 for accessing an interior space 16 of the cabin 14. The doors 18 are positioned opposite each other across the interior space 16 of the cabin 14. Each door 18 comprises a projection 22 which extends away from a main section 20 of the door 18 and forms a gap 24 between the main section 20 and the projection 22. The projection 22 may, for example, be a handle or an armrest. The projection 22 may define other elements which are attached to the main section 20 of the door 18 and protrude into the interior space 16 of the cabin 14. The vehicle 12 further includes a pair of seat assemblies 26 mounted in the cabin 14. Each seat assembly 26 is positioned adjacent to an associated one of the doors 18 and comprises a buckle receiver 28.

A pair of securement apparatuses 32 are provided which couple to and extend between an associated one of the doors 18 and the seat assembly 26 positioned adjacent to the associated door 18. Each securement apparatus 32 comprises a webbing 34, a buckle tongue 40, and a door mount 42. The buckle tongue 40 is coupled to a first end 36 of the webbing 34 and is releasably couplable to the buckle receiver 28 of the adjacent seat assembly 26. The buckle receiver 28 of each seat assembly 26 may include a release button 30 or other suitable release actuator for disengaging a latch plate or similar structure from the associated buckle tongue 40.

The door mount 42 is coupled to the webbing 34 proximate to the second end 38 of the webbing 34 and comprises a hook 44 and an engagement strap 46. The hook 44 is positioned at the second end 38 of the webbing 34, and the engagement strap 46 is coupled to the webbing 34 and is spaced from the second end 38 of the webbing 34. The engagement strap 46 forms a closed loop with the webbing 34. The hook 44 is interlinkingly engageable with the engagement strap 46. In other embodiments, the hook 44 may interlink with the projection 22 of the door 18.

Each securement apparatus 32 further includes a ratchet 48 mounted to the webbing 34 between the first end 36 and the second end 38. The ratchet 48 may be used to adjust a length of the webbing 34 between the first end 36 and the second end 38 by actuating the ratchet 48 to roll a central portion of the webbing 34, thereby pulling the first end 36 and the second end 38 of the webbing 34 toward each other. The ratchet 48 may include a release mechanism for disengaging the ratchet 48 to allow the first end 36 and the second end 38 of the webbing 34 to be urged away from each other. In some embodiments, a cam buckle or similar mechanism may be used to adjust the length of the webbing 34.

In use, each securement apparatus 32 is secured to the associated door 18 and adjacent seat assembly 26. The webbing 34 is positionable to extend through the gap 24 between the projection 22 and the main section 20 of the associated door 18 and loop around the projection 22 such that the hook 44 may be interlinkingly engaged to the engagement strap 46. The hook 44 may be threaded through the gap 24, or the webbing 34 may be slid laterally through a slot which leads to the gap 24 in some embodiments. The buckle tongue 40 may then releasably couple to the buckle receiver 28 of the seat assembly 26 which is adjacent to the associated door 18. The webbing 34 may then be shortened in length via the ratchet 48 such that the securement apparatus 32 is taut and prevents the door 18 from opening by pivoting outwardly away from the adjacent seat assembly 26.

Each securement apparatus 32 may be released by a user 50 in the cabin 14 via operating a release mechanism of the ratchet 48 or by pressing the release button 30 on the associated buckle receiver 28. By securing the doors 18 separately via different securement apparatuses 32, the user 50 may detach only one door 18 from the respective seat assembly 26 if so desired, such as if the user 50 needs to flee from an attacker or would-be attacker attempting to enter the cabin 14 from a different door 18.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A securement apparatus for a door of a vehicle, the securement apparatus comprising:
a webbing having a first end and a second end;
a buckle tongue coupled to the first end of the webbing, the buckle tongue being shaped and configured to releasably connect to a buckle receiver of a seat assembly of the vehicle; and
a door mount coupled to the webbing proximate to the second end of the webbing, the door mount being configured to mount the webbing to the door of the vehicle, wherein the door mount comprises a hook positioned at the second end of the webbing and an engagement strap coupled to the webbing and spaced from the second end of the webbing, the hook being interlinkingly engageable with the engagement strap.

2. (canceled)

3. The securement apparatus of claim 1, wherein the engagement strap forms a closed loop with the webbing.

4. The securement apparatus of claim 1, wherein a length of the webbing between the first end and the second end is adjustable.

5. The securement apparatus of claim 4, further comprising a ratchet mounted to the webbing between the first end and the second end, the length of the webbing being adjustable via the ratchet.

6. A securement apparatus for a door of a vehicle, the securement apparatus comprising:
a webbing having a first end and a second end;
a buckle tongue coupled to the first end of the webbing, the buckle tongue being shaped and configured to releasably connect to a buckle receiver of a seat assembly of the vehicle;
a door mount coupled to the webbing proximate to the second end of the webbing, the door mount comprising a hook positioned at the second end of the webbing and an engagement strap coupled to the webbing and spaced from the second end of the webbing, the engagement strap forming a closed loop with the webbing, the hook being interlinkingly engageable with the engagement strap; and
a ratchet mounted to the webbing between the first end and the second end, a length of the webbing between the first end and the second end being adjustable via the ratchet.

7. A lock system comprising:
a vehicle comprising a cabin with a door for accessing an interior space of the cabin, the vehicle further comprising a seat assembly mounted in the cabin adjacent to the door, the seat assembly comprising a buckle receiver; and
a securement apparatus configured to couple to and extend between the door of the vehicle and the seat assembly, the securement apparatus comprising:
a webbing having a first end and a second end;
a buckle tongue coupled to the first end of the webbing, the buckle tongue being shaped and configured to releasably connect to the buckle receiver of the seat assembly;
a door mount coupled to the webbing proximate to the second end of the webbing, the door mount being configured to mount the webbing to the door of the vehicle;
wherein the door of the vehicle comprises a projection which extends away from a main section of the door and forms a gap between the main section and the projection; and
wherein the door mount of the securement apparatus comprises a hook positioned at the second end of the webbing and an engagement strap coupled to the webbing and spaced from the second end of the webbing, the hook being interlinkingly engageable with the engagement strap; and
wherein the webbing of the door mount of the securement apparatus is positionable to extend through the gap between the projection and the main section of the door.

8. (canceled)

9. The lock system of claim 7, wherein the engagement strap forms a closed loop with the webbing.

10. The lock system of claim 7, wherein a length of the webbing between the first end and the second end is adjustable.

11. The lock system of claim 10, wherein the securement apparatus further comprises a ratchet mounted to the webbing between the first end and the second end, the length of the webbing being adjustable via the ratchet.

12. The lock system of claim 7, wherein the buckle receiver of the seat assembly of the vehicle comprises a release button for releasing the buckle tongue.

13. The lock system of claim 7, wherein:
the door of the vehicle is one of a pair of doors for accessing the interior space of the cabin, the pair of doors being positioned opposite each other across the interior space of the cabin, each door of the pair of doors comprising a projection which extends away from a main section of the door and forms a gap between the main section and the projection, the seat assembly being one of a pair of seat assemblies mounted in the cabin, each seat assembly of the pair of seat assemblies being positioned adjacent to an associated one of the pair of doors, each seat assembly of the pair of seat assemblies comprising the buckle receiver; and
the securement apparatus is one of a pair of securement apparatus, each securement apparatus of the pair of securement apparatus being configured to couple to and extend between an associated door of the pair of doors and an associated seat assembly of the pair of seat assemblies, each securement apparatus of the pair of securement apparatus comprising:
the webbing having a first end and a second end;
the buckle tongue coupled to the first end of the webbing, the buckle tongue being shaped and configured to releasably connect to the buckle receiver of the associated seat assembly; and
the door mount coupled to the webbing proximate to the second end of the webbing, the door mount being configured to mount the webbing to the associated door of the vehicle.

14. The lock system of claim 13, wherein:
the door mount of each securement apparatus comprises a hook positioned at the second end of the webbing and an engagement strap coupled to the webbing and spaced from the second end of the webbing, the hook being interlinkingly engageable with the engagement strap; and
the webbing of the door mount is positionable to extend through the gap between the projection and the main section of the associated door.

15. The lock system of claim 14, wherein, for each securement apparatus of the pair of securement apparatus, the engagement strap forms a closed loop with the webbing.

16. The lock system of claim 13, wherein a length of the webbing of each securement apparatus between the first end and the second end is adjustable.

17. The lock system of claim 16, wherein each securement apparatus of the pair of securement apparatus further comprises a ratchet mounted to the webbing between the first end and the second end, the length of the webbing being adjustable via the ratchet.

18. The lock system of claim 13, wherein the buckle receiver of each seat assembly comprises a release button for releasing the buckle tongue of the associated securement apparatus.
